(19) United States
(12) Patent Application Publication
(10) Pub. No.: US 2024/0137882 A1
(43) Pub. Date: Apr. 25, 2024

(54) ELECTRONIC DEVICE MEASURING REFERENCE SIGNAL RECEIVED POWER AND OPERATING METHOD OF THE ELECTRONIC DEVICE

(71) Applicant: SAMSUNG ELECTRONICS CO., LTD., SUWON-SI (KR)

(72) Inventors: Dahae Chong, Suwon-si (KR); Gunyoung Ko, Suwon-si (KR); Beomkon Kim, Suwon-si (KR); Joohyun Do, Suwon-si (KR); Myungjoon Shim, Suwon-si (KR); Yujin Sim, Suwon-si (KR)

(21) Appl. No.: 18/481,870

(22) Filed: Oct. 5, 2023

(30) Foreign Application Priority Data
Oct. 7, 2022 (KR) 10-2022-0129055
Mar. 28, 2023 (KR) 10-2023-0040758

(51) Int. Cl. H04W 56/00; H04B 17/318; H04B 17/336

(52) U.S. Cl. CPC H04W 56/0015; H04B 17/328; H04B 17/336

(57) ABSTRACT

A device may receive a first synchronization signal including at least one first synchronization signal block (SSB) from a serving base station and a second synchronization signal including at least one second SSB from a neighboring base station, where the second synchronization signal overlaps a slot through which data is transmitted from the serving base station. Additionally, the device may measure a first received power and a received reference signal received power (RSRP) of each of the first synchronization signal and the second synchronization signal received on the slot. The device may calculate an effective RSRP corresponding to at least one additional SSB received from the serving base station, the effective RSRP calculated based on a correlation power, where the correlation power is based on a cross correlation between the received RSRP, the first received power, the data, and the at least one additional SSB.

### CROSS-REFERENCE TO RELATED APPLICATION

This application is based on and claims priority under 35 U.S.C. § 119 to Korean Patent Application Numbers 10-2022-0129055, filed on Oct. 7, 2022 and 10-2023-0040758, filed on Mar. 28, 2023 in the Korean Intellectual Property office, the disclosure of which is incorporated by reference herein in its entirety.

### BACKGROUND

The present disclosure generally relates to an electronic device, and more particularly, to an electronic device measuring reference signal received power (RSRP) and a method for operating the electronic device.

Wireless communication systems are widely deployed for providing various telecommunication services such as telephony, video, data, messaging, broadcasts and so on. Some wireless communication systems employ multiple-access technologies capable of supporting communication with multiple users by sharing available system resources (e.g., bandwidth, transmit power, etc.). Examples of such multiple-access technologies include code division multiple access (CDMA) systems, time division multiple access (TDMA) systems and the like. Additionally, the systems can conform to specifications such as third generation partnership project (3GPP), 3GPP long term evolution (LTE), etc.

A wireless communication system may include a number of devices (e.g., terminals, network devices, and other devices) exchanging data, control information, reference signals, etc. (e.g., communicating) with each other. In some examples, devices operating in a wireless communication system may employ various technologies to improve throughput or achieve a high data rate. These technologies may allow a wireless communication system to support communication between an increasing number of devices, support advanced functionalities at various devices, improve the quality of communication between devices, etc. Examples of technologies employed to improve throughput may include beamforming, massive multiple-input multiple-output (MIMO), full-dimensional MIMO (FD-MIMO), antenna arrays, analog beamforming, large-scale antenna technologies, etc.

To support mobility functions, cellular communication systems including 5G communication systems periodically measure the RSRP of a base station to which a terminal or electronic device is currently connected and the RSRPs of neighboring base stations. The terminal or electronic device may perform a handover to one of the neighboring base stations corresponding to a higher RSRP by comparing the RSRP of the base station currently connected thereto with the RSRPs of the neighboring base stations. However, in some cases, the terminal or electronic device may make inefficient handover decisions (e.g., such as performing a handover to a base station that has a low channel quality). Accordingly, there is a need in the art for efficient handover techniques within wireless communication systems.

### SUMMARY

The present disclosure describes a device measuring effective reference signal received powers (RSRPs) of neighboring base stations while removing interference effect of a serving base station and a method for operating the device.

According to an aspect of the present disclosure, a method is described that includes receiving a first synchronization signal including at least one first synchronization signal block (SSB) from a serving base station and a second synchronization signal including at least one second SSB from a neighboring base station, where the second synchronization signal including the at least one second SSB overlaps a slot through which data is transmitted from the serving base station; measuring a first received power and a received RSRP of each of the first synchronization signal and the second synchronization signal received on the slot; and calculating an effective RSRP corresponding to at least one additional SSB received from the serving base station, the effective RSRP calculated based at least in part on a correlation power, where the correlation power is based at least in part on a cross correlation between the received RSRP, the first received power, the data, and the at least one additional SSB.

According to another aspect of the present disclosure, an apparatus (e.g., an electronic device) is described that includes a communication circuit configured to receive a first synchronization signal including data on a resource of at least one first SSB from a serving base station and to receive a second synchronization signal including at least one second SSB from a neighboring base station, the second synchronization signal including the at least one second SSB transmitted to an additional resource that corresponds to the resource of the at least one first SSB that includes the data; a memory configured to store a simulation value of a correlation coefficient based on cross correlation between the data and the at least one second SSB; and a control circuit, where the control circuit includes an RSRP update circuit configured to measure each of a received RSRP and a first received power based at least in part on using the data received on the resource and the at least one second SSB and to calculate an effective RSRP corresponding to at least one additional SSB received from the serving base station, the effective RSRP calculated based at least in part on the received RSRP, the first received power, and a simulation value stored in the memory.

According to another aspect of the present disclosure, a wireless communication system is described that includes a serving base station configured to transmit, to an electronic device, a first synchronization signal block (SSB) burst set including a first SSB and data; a neighboring base station configured to transmit, to the electronic device, a second SSB burst set including a second SSB, the second SSB transmitted on an additional slot that corresponds to a slot for the data; and the electronic device configured to measure each of a first received power, a received RSRP, and a signal-to-interference-plus-noise ratio (SINR) based at least in part on the data received on the slot and the second SSB and to calculate, based at least in part on determining the SINR is less than a threshold, an effective RSRP corresponding to the second SSB based at least in part on the received RSRP, the first received power, the data, and a correlation power, the correlation power based on a cross correlation of the second SSB.

### BRIEF DESCRIPTION OF THE DRAWINGS

Embodiments will be more clearly understood from the following detailed description taken in conjunction with the accompanying drawings in which:

FIG. 1 is a diagram of a wireless communication system according to an embodiment of the present disclosure;

FIG. 2 is a block diagram of a base station according to an embodiment of the present disclosure;

FIG. 3 is a block diagram of an electronic device according to an embodiment of the present disclosure;

FIG. 4A illustrates an example of a signal received by an electronic device from a serving base station according to an embodiment of the present disclosure;

FIG. 4B illustrates an example of a signal received by an electronic device from a neighboring base station according to an embodiment of the present disclosure;

FIG. 5 illustrates a signal exchange of a wireless communication system according to an embodiment of the present disclosure;

FIG. 6 is a flowchart of a detailed operating method of calculating effective reference signal received power (RSRP) according to an embodiment of the present disclosure;

FIG. 7 is a graph illustrating RSRP measurement values according to an interference effect according to an embodiment of the present disclosure; and

FIG. 8 is a block diagram of a wireless communication device according to an embodiment of the present disclosure.

### DETAILED DESCRIPTION OF THE EMBODIMENTS

A wireless communication system may generally include or refer to a number of devices employing techniques for exchanging information wirelessly. For example, a wireless communication system may include terminals (e.g., user devices or user equipment) and base stations (or network entities) that wirelessly communicate data, control information, reference signals, etc. (e.g., according to various wireless communication system implementations).

To meet the demand for wireless data traffic having increased since deployment of 4th generation (4G) communication systems, efforts have been made to develop an improved 5th generation (5G) or pre-5G communication system. Therefore, the 5G or pre-5G communication system may also be called a ‘beyond 4G network’ or a ‘post long term evolution (LTE) system’. The 5G communication system may be considered to be implemented in higher frequency (e.g., millimeter wave (mmW)) bands, such as 60 GHz bands, so as to accomplish higher data rates.

Techniques including, for example, beamforming, massive multiple-input multiple-output (MIMO), full dimensional-MIMO (FD-MIMO), array antenna, and analog beam forming may be implemented in 5G communication systems to decrease propagation loss of radio waves and increase transmission distances. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation, and the like.

To support mobility functions, cellular communication systems (e.g., including 5G communication systems) may periodically perform channel quality measurements (e.g., reference signal received power (RSRP) measurements, reference signal received quality (RSRQ) measurements, received signal strength indicator (RSSI) measurements, etc.) of a serving base station (e.g., a base station to which a terminal or electronic device is currently connected) and channel quality measurements of neighboring base stations. In some cases, the terminal or electronic device may perform a handover from the serving base station to one of the neighboring base stations corresponding to a better channel quality (e.g., higher RSRP or RSRQ) by comparing the channel quality measurements of the serving base station with the channel quality measurements of the neighboring base stations. However, in some cases, the terminal or electronic device may perform a handover to a base station that has a low channel quality due to inaccurate channel quality measurements of the neighboring base stations.

For example, a serving base station (e.g., serving cell, network entity, etc.) may include data on a resource of a synchronization signal block (SSB) to transmit to an electronic device. As channel quality improves, the serving base station may transmit the data to the electronic device with high transmission power to increase throughput. However, the data received from the serving base station may cause strong interference when the electronic device performs measurements of neighboring base stations (e.g., power measurements, channel quality measurements, RSRP, etc.) to determine whether to perform a handover to a neighboring base station or an additional base station. For example, when the electronic device measures RSRP (or another channel quality measurement) of the neighboring base station, over-measurement of the RSRP may occur due to received power of the data (e.g., on the resource of the SSB). Subsequently, due to the over-measured RSRP, issues may arise when attempting to perform a handover to a neighboring base station having poor channel quality.

As provided herein, techniques and methods are described for an electronic device to measure effective RSRP of a neighboring base station by using received RSRP and received signal power when attempting to perform a handover to the neighboring base station. The electronic device may determine whether to measure the effective RSRP by measuring an additional channel quality (e.g., signal-to-interference-plus-noise ratio (SINR), signal-to-noise ratio (SNR), etc.). When channel quality is less than a threshold (e.g., SINR is less than a threshold), the electronic device may determine to calculate the effective RSRP of the neighboring base station. The electronic device may estimate received power of data from a serving base station by using the received RSRP, received signal power, and a power value generated due to cross correlation based on an SSB sequence. Subsequently, the electronic device may obtain the effective RSRP by subtracting a product of the received power of the data and a power value generated by the cross correlation from the received RSRP.

Hereinafter, embodiments of the present disclosure will be described in detail with reference to the accompanying drawings.

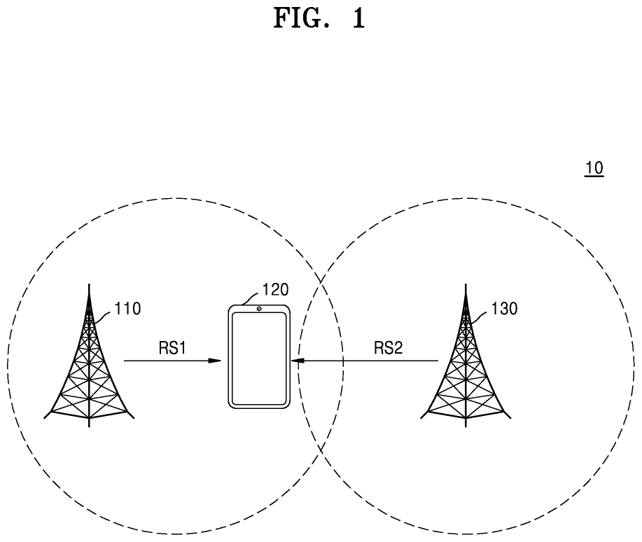

FIG. 1 is a diagram of a wireless communication system 10 according to an embodiment of the present disclosure.

Referring to FIG. 1, the wireless communication system 10 may include a serving base station 110, an electronic device 120, and a neighboring base station 130.

In some embodiments, the serving base station 110 may include a network infrastructure providing a wireless access to the electronic device 120. The serving base station 110 may have a coverage defined as a certain geographic area based on a distance to which a signal may be transmitted. The serving base station 110 may be referred to, in addition to a base station, as an ‘access point’ (AP), ‘eNodeB’ (eNB), a ‘5^{th} generation (5G) node,’ a ‘wireless point,’ or other terms having the same technical concept.

Additionally, in some embodiments, the serving base station 110 may be connected to one or more ‘transmission/reception points’ (TRPs). The serving base station 110 may transmit a downlink signal to or receive an uplink signal from the electronic device 120 via one or more TRPs.

In some embodiments, the serving base station 110 and the neighboring base station 130 may broadcast a synchronization signal. The synchronization signal may include a signal for synchronizing between the electronic device 120 and the serving base station 110 or the neighboring base station 130. For example, the serving base station 110 may broadcast a first reference signal RS1, and the neighboring base station 130 may broadcast a second reference signal RS2. In some examples, the neighboring base station 130 may transmit the second reference signal RS2 at the same time as the serving base station 110 transmitting a downlink signal (e.g., physical downlink shared channel (PDSCH)) to the electronic device 120.

In some embodiments, the electronic device 120 may include a device used by a user. Additionally, the electronic device 120 may communicate with the serving base station 110 via a wireless channel. The electronic device 120 may be referred to, in addition to ‘terminal,’ as a user equipment (UE), a mobile station, a subscriber station, customer premises equipment (CPE), a remote terminal, a wireless terminal, a user device, or other terms having equivalent technical concepts.

In some embodiments, the electronic device 120 may receive a synchronization signal from each of the serving base station 110 and the neighboring base station 130. For example, the electronic device 120 may receive the first reference signal RS1 from the serving base station 110 and may receive the second reference signal RS2 from the neighboring base station 130. The electronic device 120 may receive the first reference signal RS1 and the second reference signal RS2 to determine a handover based on the signal strength of the reference signals. For example, when the signal strength of the second reference signal RS2 is greater than the signal strength of the first reference signal RS1, the electronic device 120 may determine that the electronic device 120 is moving in the direction in which the neighboring base station 130 is located. Additionally, the electronic device 120 may determine the signal quality is better when the electronic device 120 is connected to the neighboring base station 130 based on the higher signal strength of the second reference signal RS2 received from the neighboring base station 130. Accordingly, the electronic device 120 may determine to perform a handover to the neighboring base station 130 when the signal strength of the second reference signal RS2 is greater than the signal strength of the first reference signal RS1.

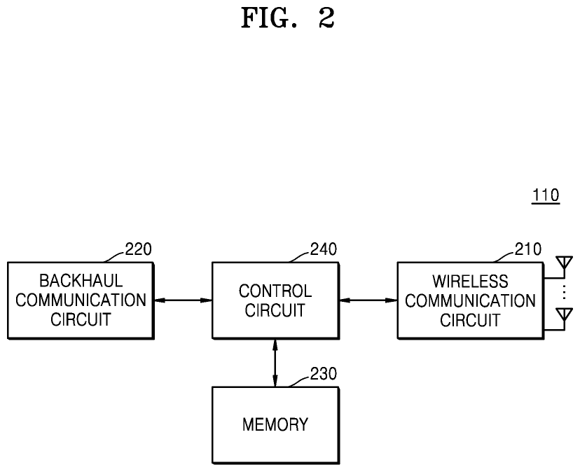

FIG. 2 is a block diagram of the serving base station 110 according to an embodiment of the present disclosure. The serving base station 110 may represent aspects of or may be represented by aspects of the serving base station 110 as described with reference to FIG. 1.

Referring to FIG. 2, the serving base station 110 may include a wireless communication circuit 210, a backhaul communication circuit 220, a memory 230, and a control circuit 240.

The wireless communication circuit 210 may transceive signals via a wireless channel. In some embodiments, the wireless communication circuit 210 may perform a conversion function between a baseband signal and a bit string according to a physical layer standard of a system. For example, during data transmission, the wireless communication circuit 210 may generate complex symbols by encoding and modulating a transmission bit string and, during data receiving, may restore a received bit string by demodulating and decoding the baseband signal. Additionally, the wireless communication circuit 210 may upwardly convert the baseband signal into a radio frequency (RF) band signal and transmit the converted baseband signal via an antenna or may downwardly convert the RF band signal received via the antenna into the baseband signal. To this end, the wireless communication circuit 210 may include a transmission filter, a receiving filter, an amplifier, a mixer, an oscillator, a digital to analog converter (DAC), an analog to digital converter (ADC), etc.

The wireless communication circuit 210 may transceive signals. For example, the wireless communication circuit 210 may transmit a synchronization signal, a reference signal, system information, a message, control information, data, etc. In addition, the wireless communication circuit 210 may perform beamforming. The wireless communication circuit 210 may apply a beamforming weight to a signal to be transceived to impart directionality to the signal. The wireless communication circuit 210 may repeatedly transmit a signal by changing the formed beam.

In some aspects, wireless communication circuit 210 may receive information such as packets, user data, or control information associated with various information channels (e.g., control channels, data channels, etc.). Information received at wireless communication circuit 210 may be passed on to other components of the device, such as control circuit 240, etc. In some aspects, wireless communication circuit 210 may transmit signals generated by other components (e.g., such as control circuit 240, etc.). In some cases, wireless communication circuit 210 may be an example of aspects of a transceiver (e.g., in some cases, wireless communication circuit 210 may be capable of concurrently transmitting or receiving multiple wireless transmissions). In various examples, wireless communication circuit 210 may utilize a single antenna or a plurality of antennas.

The backhaul communication circuit 220 may provide an interface for performing communication with other nodes in the network. For example, the backhaul communication circuit 220 may convert a bit string transmitted from the serving base station 110 to another node, for example, another connection node, another base station, an upper node, a core network, or the like, into a physical signal. Additionally, the backhaul communication circuit 220 may convert the physical signal received from another node into a bit string.

The memory 230 may store data, such as a basic program, an application program, and setting information for an operation of the serving base station 110. The memory 230 may include a volatile memory, a non-volatile memory, or a combination thereof. For example, the memory 230 may include at least one of cell identification (ID), long term evolution (LTE) bandwidth, LTE center frequency position, multicast-broadcast single-frequency network (MBSFN) configuration information, and test-driven development (TDD) configuration information, of at least one neighboring base station adjacent to the serving base station 110.

The control circuit 240 may control operations of the serving base station 110. For example, the control circuit 240 may transceive signals via the wireless communication circuit 210 or the backhaul communication circuit 220. Additionally, the control circuit 240 may record data in and read data from the memory 230. To this end, the control circuit 240 may include at least one processor.

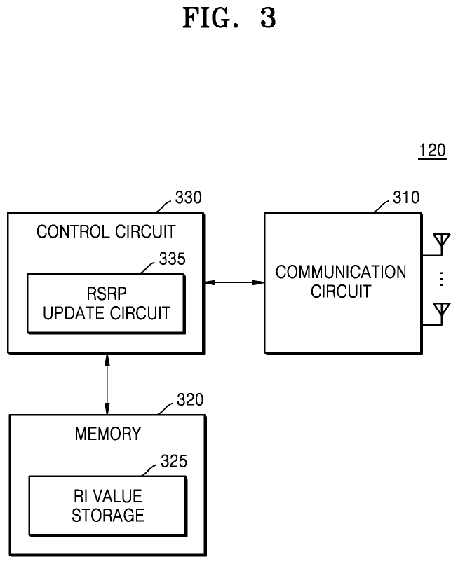

FIG. 3 is a block diagram of the electronic device 120 according to an embodiment of the present disclosure. The electronic device 120 may represent aspects of or may be represented by aspects of the electronic device 120 as described with reference to FIG. 1. Additionally, the electronic device 120 may communicate with the serving base station 110 as described with reference to FIGS. 1 and 2 and/or with the neighboring base station 130 as described with reference to FIG. 1.

Referring to FIG. 3, the electronic device 120 may include a communication circuit 310, a memory 320, and a control circuit 330.

The communication circuit 310 may transceive signals via a wireless channel. For example, the communication circuit 310 may perform a conversion function between a baseband signal and a bit string according to a physical layer standard of a system. For example, during data transmission, the communication circuit 310 may generate complex symbols by encoding and modulating a transmission bit string and, during data receiving, may restore a received bit string by demodulating and decoding the baseband signal. Additionally, the communication circuit 310 may upwardly convert the baseband signal into an RF band signal or may downwardly convert the RF band signal received via the antenna into the baseband signal. For example, the communication circuit 310 may include at least a transmission filter, a receiving filter, an amplifier, a mixer, an oscillator, a DAC, an ADC, etc. The communication circuit 310 may perform beamforming. The communication circuit 310 may apply a beamforming weight to a signal to be transceived to impart directionality to the signal.

The communication circuit 310 may transceive signals. For example, the communication circuit 310 may receive a downlink signal. The downlink signal may include a synchronization signal (SS), a reference signal, system information, a configuration message, control information, downlink data, etc. Additionally, the communication circuit 310 may transmit a uplink signal. The uplink signal may include a random access-related signal, a reference signal (e.g., sounding reference signal (SRS), demodulation reference signal (DM-RS), etc.), or uplink data.

The memory 320 may store data, such as a basic program, an application program, and setting information, for an operation of the electronic device 120. The memory 320 may include a volatile memory, a non-volatile memory, or a combination thereof. In addition, the memory 320 may provide stored data according to a request of the control circuit 330.

In some embodiments, the memory 320 may store an R_{I} simulation average value. The R_{I} may include a value representing the power term of the receiving signal, which is caused by the cross correlation between the downlink signal (e.g., PDSCH) of the serving base station 110 and the second reference signal RS2 of the neighboring base station 130. In other words, the memory 320 may store an R_{I} simulation average value in R_{I} value storage 325 obtained by simulating the R_{I} to calculate the effective RSRP of the neighboring base station 130, and the electronic device 120 may use the R_{I} simulation average value to estimate the received power of the downlink signal received from the serving base station 110. In some aspects, cross correlation between signals (e.g., between received RSRP, received power, data, SSBs, etc.) may include, or refer to, a measure of similarity between signals (e.g., as a function of a time-lag applied to one of the signals). For instance, in some aspects, a signal may be a representation of a sequence of numerical values. Cross correlation may provide a way to analyze or compare two signals (e.g., while considering different time-lags) to identify delays, similarities, relationships between the signals, etc. As described in more detail herein, cross correlation aspects may be used to calculate effective RSRP, in order to more accurately determine when to perform handover operations (e.g., to determine whether a handover condition is satisfied based on the effective RSRP and the received RSRP corresponding to a received SSB).

The control circuit 330 may control overall operations of the electronic device 120. For example, the control circuit 330 may transceive signals via the communication circuit 310. Additionally, the control circuit 330 may record data in and read data from the memory 320. To this end, the control circuit 330 may include at least one processor or a microprocessor or may include a portion of a processor. In the case of a portion of the processor, a portion of the communication circuit 310 and the control circuit 330 may be referred to as a communication processor (CP).

In some embodiments, the control circuit 330 may further include an RSRP update circuit 335. The RSRP update circuit 335 may include circuitry for measuring the effective RSRP of the second reference signal RS2 received from the neighboring base station 130. For example, the RSRP update circuit 335 may estimate the RSRP (e.g., the effective RSRP) of only the second reference signal RS2 received from the neighboring base station 130 based on the RSRP measured by the electronic device 120 and received signal power (RSP) measured by the electronic device 120. The RSRP update circuit 335 may estimate the power of the downlink signal (e.g., the power of the measured RSP) received from the serving base station 110 based on the measured RSRP, the RSP, and the average R_{I} simulation average value stored in the memory 320. The RSRP update circuit 335 may estimate the effective RSRP due to the neighboring base station 130 by removing the estimated power of the downlink signal of the serving base station 110 from the measured RSRP. Detailed descriptions of this activity are provided herein.

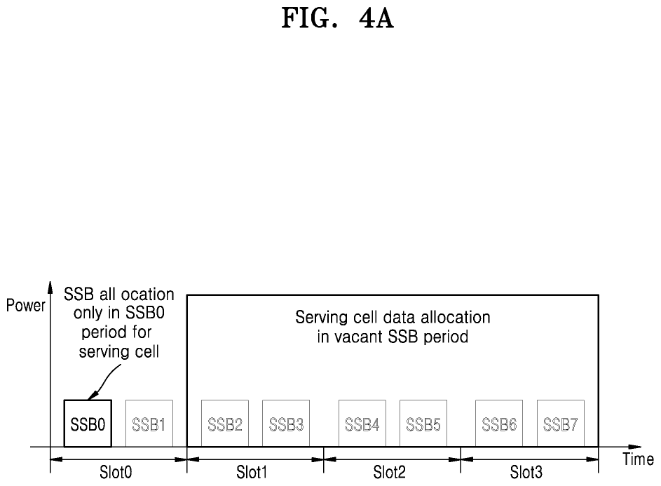

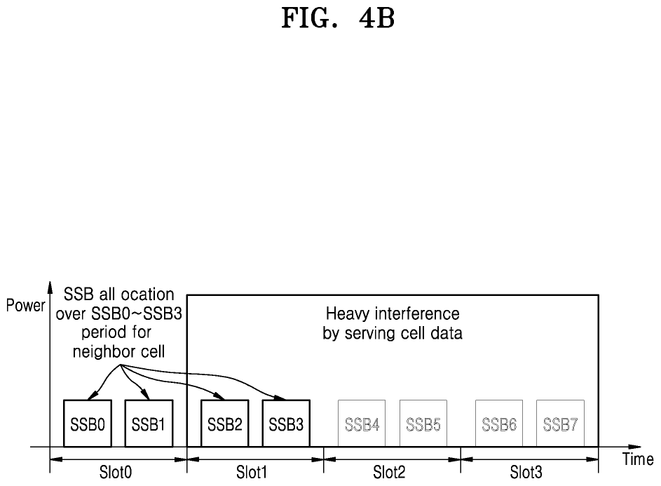

FIG. 4A illustrates an example of a signal received by the electronic device 120 from the serving base station 110 according to an embodiment of the present disclosure. FIG. 4B illustrates an example of a signal received by the electronic device 120 from the neighboring base station 130 according to an embodiment of the present disclosure. The serving base station 110, the electronic device 120, and the neighboring base station 130 may represent aspects of or may be represented by aspects of the respective devices as described with reference to FIGS. 1-3.

Referring to FIG. 4A, the serving base station 110 may transmit a first SSB (SSB0) to the electronic device 120. In some embodiments, the serving base station 110 may transmit an SSB burst set to the electronic device 120. The SSB burst set may be referred to as a continuous SSB transmitted to the electronic device 120. For example, the SSB burst set may include eight SSBs. The serving base station 110 may allocate the SSBs so that at least one SSB of the eight SSBs (e.g., SSB0 through SSB7) is transmitted. For example, the serving base station 110 may allocate the most preceding SSB or the first SSB (e.g., SSB0) to the electronic device 120. The serving base station 110 may transmit data on a resource of at least one of the remaining SSBs not allocated to the electronic device 120 (e.g., SSB1 through SSB7). For example, the serving base station 110 may transmit data to the electronic device 120 on resources of the third through eighth SSB s (e.g., SSB2 through SSB7).

As described, the SSB burst set has been described as including eight SSBs but is not limited thereto. In some embodiments, the SSB burst set may vary depending on an operating frequency.

Referring to FIG. 4B, the neighboring base station 130 may transmit first through fourth SSBs (e.g., SSB0 through SSB3) to the electronic device 120. The neighboring base station 130 may allocate the SSBs so that at least one SSB of the eight SSBs (e.g., SSB0 through SSB7) included in the SSB burst set are transmitted. For example, the neighboring base station 130 may continuously allocate four SSBs (e.g., SSB0 through SSB3) to the electronic device 120.

In some embodiments, the electronic device 120 may simultaneously receive signals from the serving base station 110 and the neighboring base station 130. For example, the electronic device 120 may receive data on resources of the third SSB through the eighth SSB (e.g., SSB2 through SSB7) from the serving base station 110. Additionally, the electronic device 120 may receive the third and fourth SSBs (e.g., SSB2 and SSB3) from the neighboring base station 130. That is, the electronic device 120 may receive data from the serving base station 110 and the SSBs from the neighboring base station 130 at the times that the third and fourth SSBs (e.g., SSB2 and SSB3), respectively, are received.

When transmitting data to the electronic device 120 on the resources of the third and fourth SSBs (e.g., SSB2 and SSB3), the serving base station 110 may use a high transmission power. For example, the serving base station 110 may increase the strength of transmission power to improve the throughput of transmission data as the wireless environment has a higher SNR. At the same time, the electronic device 120 may receive the third and fourth SSB s (e.g., SSB2 and SSB3) from the neighboring base station 130 at the time points of the third and fourth SSBs (e.g., SSB2 and SSB3), respectively. Accordingly, when the electronic device 120 measures the RSRP of the neighboring base station 130, the RSRP of the neighboring base station 130 may be over-measured (e.g., because the data, or receiving signal, may be received based on a high transmission power from the serving base station 110 together with the third and fourth SSB, SSB2 and SSB3, received from the serving base station 110). For example, it may be assumed that the RSRP value based on the SSB received from the serving base station 110 is −80 dBm. When the serving base station 110 is closer to the electronic device 120 than the neighboring base station 130, the RSRP value based on the SSB received from the neighboring base station 130 may be less than −80 dBm. For example, the RSRP value measured based only on the SSB received from the neighboring base station 130 may be −90 dBm. However, as illustrated in FIGS. 4A and 4B, when the serving base station 110 transmits data on the resources of the SSBs with high transmission power at the time point when the neighboring base station 130 broadcasts the SSB, the RSRP value measured by the electronic device 120 may be −70 dBm. Thus, although the electronic device 120 has a worse wireless channel with the neighboring base station 130 (e.g., the wireless channel with the neighboring base station 130 has a lower channel quality than a wireless channel with the serving base station 110), there may be an issue of performing a handover based on the over-measured RSRP.

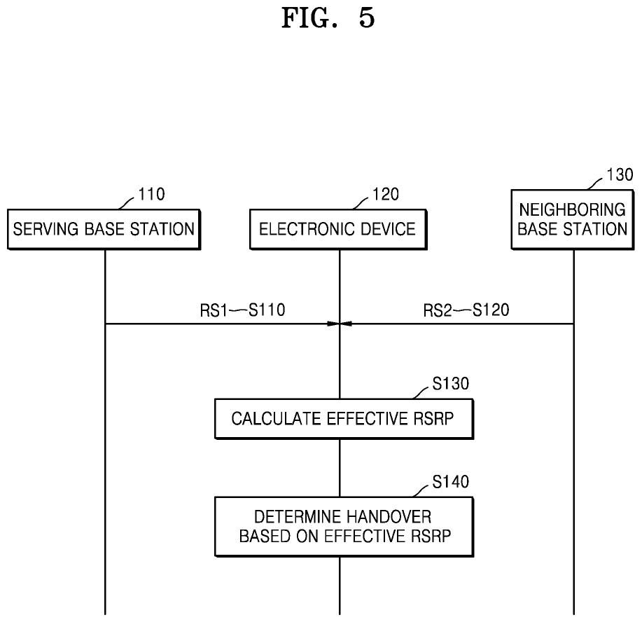

FIG. 5 illustrates a signal exchange of a wireless communication system according to an embodiment of the present disclosure. The signal exchange of the wireless communication system of FIG. 5 may include a serving base station 110, an electronic device 120, and a neighboring base station 130, which may represent aspects of or may be represented by aspects of the respective devices as described with reference to FIGS. 1-4B.

Referring to FIG. 5, in operation S110, the serving base station 110 may transmit the first reference signal RS1 and data to the electronic device 120. The serving base station 110 may transmit the first reference signal RS1 including at least one SSB of the SSB burst set to the electronic device 120. Referring to FIG. 4A together, the first reference signal RS1 may include the first SSB (e.g., SSB0). The serving base station 110 may transmit data on the resource of at least one of the remaining SSBs except for the at least one SSB of the SSB burst set. For example, referring to FIG. 4A together, the data may be transmitted on the resources of the third and fourth SSBs (e.g., SSB2 and SSB3) of the described SSB burst set.

In operation S120, the neighboring base station 130 may transmit the second reference signal RS2 to the electronic device 120. The neighboring base station 130 may transmit the second reference signal RS2 including at least one SSB of the SSB burst set to the electronic device 120. Referring to FIG. 4B together, the second reference signal RS2 may include the first through fourth SSBs (e.g., SSB0 through SSB3). In some embodiments, operation S110 and operation S120 may be performed simultaneously. For example, the electronic device 120 may receive data from the serving base station 110 on the resources of the third and fourth SSBs (e.g., SSB2 and SSB3) and, at the same time, may receive the third and fourth SSB s (e.g., SSB2 and SSB3) from the neighboring base station 130.

In operation S130, the electronic device 120 may calculate the effective RSRP. To calculate the effective RSRP of the neighboring base station 130, the electronic device 120 may measure each of the received RSRP and received signal (RS) power. A k^{th} reference signal after the electronic device 120 descrambles the RSs received at the time points of the third and fourth SSBs (e.g., SSB2 and SSB3) may be represented by Equation 1.

Yₖ=\sqrt{P_{N}}+\sqrt{P_{I}}DₖSₖ [symbol] +WₖSₖ [symbol] (1)

In Equation 1, P_{N} may represent the received power of an SSB (e.g., the third SSB (SSB2) and the fourth SSB (SSB3)) received from the neighboring base station 130, P_{I} may represent received power of data transmitted by the serving base station 110 at the same time points of the third SSB (SSB2) and the fourth SSB (SSB3), Dₖ may represent data overlapped at a position of the k^{th} reference signal, Sₖ may represent a code sequence of the k^{th} reference signal, Wₖ and may represent a noise component included at the position of the k^{th} reference signal.

The data overlapped at a position of the k^{th} reference signal may be normalized, and E[|Dₖ|²] may satisfy 1. |Sₖ|² of the code sequence may satisfy 1. The noise may include an additive white Gaussian noise (AWGN) in which the average satisfies 0 and the dispersion satisfies σ².

The electronic device 120 may measure the RS power at the position of the k^{th} reference signal, and the RS power may be represented by Equation 2.

$$RS Power = \frac{1}{K} {\sum }_{k = 0}^{K = 1} {\vert {Y}_{k} \vert}^{2} \qquad ( 2 )$$

In this case, it may be assumed that the received power of the data received from the serving base station 110 is much greater than the received power of the SSB received from the neighboring base station 130 (P_{I}>>P_{N}>>σ²). In this case, the RS power may be represented by Equation 3.

RS Power≅P_{N}+P_{I} (3)

Additionally, the electronic device 120 may measure the received RSRP. In some embodiments, when the received power of the data received from the serving base station 110 is assumed to be greater than the received power of the SSB received from the neighboring base station 130 (P_{I}>>P_{N}>>σ²), the received RSRP may be calculated by using Equation 4.

RSRP≅P_{N}+P_{I}R_{I} (4)

In this case, P_{N} may represent the received power of the third SSB (SSB2) and the fourth SSB (SSB3) received from the neighboring base station 130, P_{I} may represent received power of data transmitted by the serving base station 110 at the same time points of the third SSB (SSB2) and the fourth SSB (SSB3), R_{I} may represent power generated by cross correlation based on the data of the serving base station 110 and the SSB sequence of the third SSB (SSB2) and fourth SSB (SSB3) of the neighboring base station 130.

By using the received RSRP and the received signal power, the received power of the data received from the serving base station 110 may be represented by Equation 5.

$${P}_{I} = \frac{RS Power - RSRP}{1 - {R}_{I}} \qquad ( 5 )$$

In this case, R_{I} may represent power generated by the cross correlation between Dₖ and Sₖ, and in general, R_{I} may be designed to be less than 1. The electronic device 120 may estimate the power P_{I} of the data received from the serving base station 110 by substituting the R_{I} simulation average value stored in the memory 320, as described with reference to FIG. 3, into Equation 5.

$$≅ \frac{RS Power - RSRP}{1 -} \qquad ( 6 )$$

Based on Equation 6, [symbol] may represent the R_{I} simulation average value pre-stored in the memory 320, and [symbol] may represent the estimated value of the received power of the data received from the serving base station 110. By using the estimated value of the received power of the data and the R_{I} simulation average value, the effective RSRP with the effect of interference by the serving base station 110 removed may be calculated by Equation 7.

RSRP_{eff}=RSRP− [symbol] [symbol] (7)

In operation S140, the electronic device 120 may determine to perform a handover based on the effective RSRP. For example, the electronic device 120 may compare the received RSRP of the first SSB (SSB0) received from the serving base station 110 with the effective RSRPs of the third SSB (SSB2) and the fourth SSB (SSB3) received from the neighboring base station 130. When the effective RSRP corresponding to the neighboring base station 130 is greater than the received RSRP corresponding to the serving base station 110, the electronic device 120 may determine to perform the handover from the serving base station 110 to the neighboring base station 130.

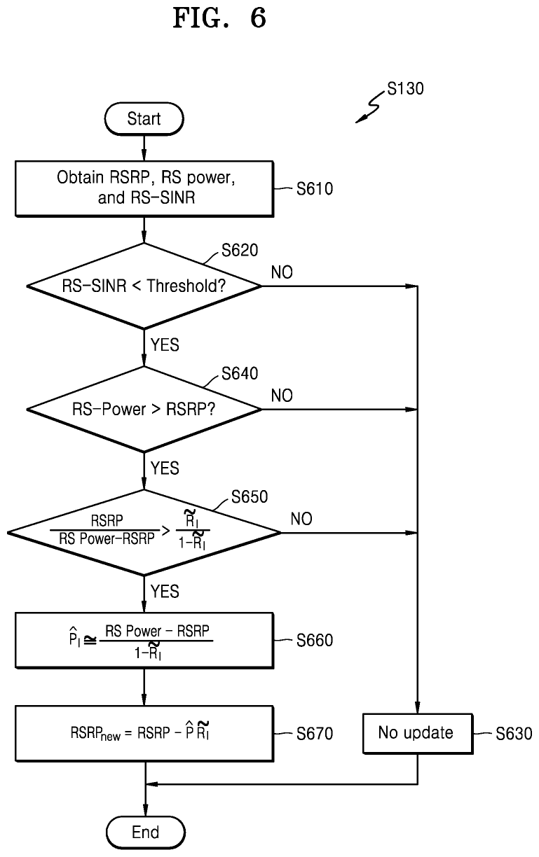

FIG. 6 is a flowchart of a detailed operating method of calculating the effective RSRP according to an embodiment of the present disclosure. In some embodiments, the electronic device 120 as described with reference to FIGS. 1-5 may be configured to perform the operating method of calculating the effective RSRP as illustrated and described with reference to FIG. 6.

Referring to FIG. 6, in operation S610, the electronic device 120 may obtain the received RSRP, the RS power, and an RS-SINR.

In operation S620, the electronic device 120 may determine whether the RS-SINR is less than a threshold. The electronic device 120 may calculate the effective RSRP of the neighboring base station 130 when the RS-SINR is less than the threshold. When there is no or less interference impact (e.g., the RS-SINR is greater than the threshold), the RSRP of the neighboring base station 130 may be accurately measured without interference, and thus, calculating the effective RSRP may be unnecessary and may rather increase the complexity of the electronic device 120. When the RS-SINR exceeds a threshold, the electronic device 120 may proceed to operation S630 to skip or bypass an RSRP update. When the RS-SINR is less than the threshold, the electronic device 120 may proceed to operation S640.

In operation S640, the electronic device 120 may determine whether the received signal power exceeds the received RSRP. When the received signal power is less than the received RSRP, the electronic device 120 may proceed to operation S630 and may not perform the RSRP update. This is because when the received signal power is less than the received RSRP, P_{I} according to Equation 5 becomes a negative value. That is, the electronic device 120 may determine whether the RS power exceeds the received RSRP in operation S640 to avoid the case in which P_{I} is not defined. When the RS power exceeds the received RSRP, the electronic device 120 may proceed to operation S650.

In operation S650, the electronic device 120 may determine whether Equation 8 is satisfied by using the RS power, the received RSRP, the R_{I} simulation average value or [symbol] .

$$\frac{RSRP}{RS Power - RSRP} > \frac{1 -}{} \qquad ( 8 )$$

The condition of Equation 8 may include a condition except for the case in which RSRP_{eff} becomes less than 0 by inputting [symbol] of Equation 6 into RSRP_{eff} of Equation 7. The case in which the condition described above is not satisfied may indicate the case in which RSRP_{eff} is less than 0 and thus is not defined. Accordingly, the electronic device 120 may proceed to operation S630 to skip the RSRP update.

In operation S660, the electronic device 120 may calculate [symbol] . The electronic device 120 may obtain [symbol] or the estimated value of power of the data received from the serving base station 110 by substituting the R_{I} simulation average value stored in the memory 320 into Equation 5 described previously.

In operation S670, the electronic device 120 may calculate the effective RSRP. For example, the electronic device 120 may obtain the effective RSRP based on the SSB of the neighboring base station 130, by subtracting, from the received RSRP, a value obtained by multiplying [symbol] obtained in operation S660 to [symbol] , which is the R_{I} simulation average value stored in the memory 320.

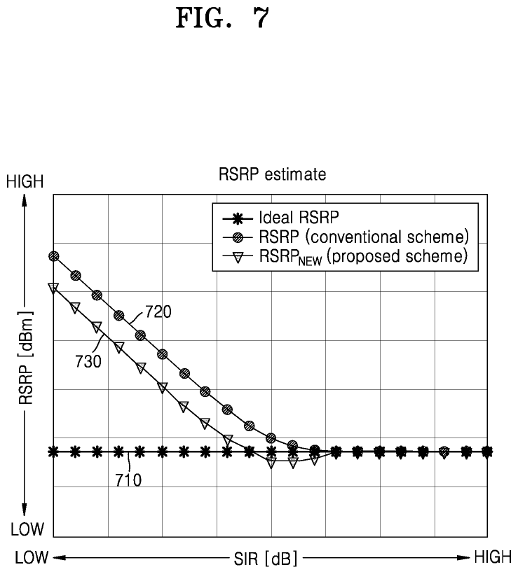

FIG. 7 is a graph illustrating RSRP measurement values according to an interference effect according to an embodiment of the present disclosure. In some embodiments, the graph illustrating RSRP measurement values may represent RSRP measurements values obtained by an electronic device 120 based on signals received from a serving base station 110, a neighboring base station 130, or both as described herein and with reference to FIGS. 1-6.

Referring to FIG. 7, a first graph 710 may represent an ideal RSRP. For example, it may be assumed that the electronic device 120 measures the RSRP based on the SSB of the neighboring base station 130 regardless of interference caused by the signal of the serving base station 110. Referring to the first graph 710, it is identified that the RSRP of the case where the serving base station 110 transmits data at low transmission power with a high signal-to-interference ratio (SIR) is the same as the RSRP of the case where the serving base station 110 transmits data at high transmission power with a low SIR. For example, according to the first graph 710, the ideal RSRP may maintain a constant value regardless of the magnitude of the transmission power of the data from the serving base station 110.

A second graph 720 may represent the RSRP according to a comparison example. According to the second graph 720, it is identified that as the SIR decreases, the measurement value of the RSRP increases. For example, in a region where data is transmitted by the serving base station 110 with low transmission power and high SIR, the data from the serving base station 110 may cause little or weak interference effects. Accordingly, it is identified that the RSRP of the second graph 720 in a region with high SIR is similar to the ideal RSRP of the first graph 710. When the serving base station 110 transmits data with high transmission power, the SIR may be reduced. For example, when the serving base station 110 transmits data with high transmission power, the transmitted data may act as interference in a situation where the electronic device 120 measures the RSRP of the neighboring base station 130. However, because cross correlation based on the SSB sequence occurs, it is identified that the RSRP of the neighboring base station 130 measured by the electronic device 120 increases.

A third graph 730 may represent an RSRP measured according to an embodiment of the present disclosure. For example, the RSRP of the third graph 730 may correspond to the effective RSRP. According to the third graph 730, as the SIR decreases, the measurement value of the RSRP may increase, which is the same as the case of the second graph 720. At the same time, the RSRP value according to the third graph 730 may be measured to be less than the RSRP of the second graph 720 by 4 dB below the point where the SIR is −4 dB. This may be because, as described previously, the power value according to the cross correlation of the data received from the serving base station 110 has been subtracted.

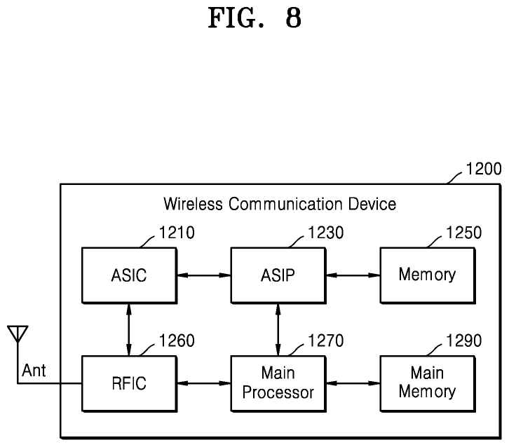

FIG. 8 is a block diagram of a wireless communication device 1200 according to an embodiment of the present disclosure.

Referring to FIG. 8, the wireless communication device 1200 may include a modulator/demodulator (modem) (not illustrated) and a radio frequency integrated circuit (RFIC) 1260, and the modem may include an application-specific integrated circuit (ASIC) 1210, an application-specific instruction set processor (ASIP) 1230, a memory 1250, a main processor 1270, and a main memory 1290. The wireless communication device 1200 in FIG. 8 may include the electronic device 120 as described with reference to FIG. 1-7 according to an embodiment of the present disclosure.

The RFIC 1260 may be connected to an antenna (Ant) and, by using a wireless communication network, may receive signals from the outside or transmit signals to the outside. The ASIP 1230 may include an integrated circuit customized for a particular usage, support a dedicated instruction set for a particular application, and execute instructions included in the dedicated instruction set. The memory 1250 may communicate with the ASIP 1230, and may also store, as a non-volatile storage, a plurality of instructions executed by the ASIP 1230. For example, the memory 1250 may include an arbitrary type of memory accessible by the ASIP 1230 as a non-limited example, such as random access memory (RAM), read-only memory (ROM), a tape, a magnetic disk, an optical disk, a volatile memory, a non-volatile memory, and a combination thereof.

Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

In some aspects, main processor 1270 may be an intelligent hardware device, (e.g., a general-purpose processing component, a digital signal processor (DSP), a central processing unit (CPU), a graphics processing unit (GPU), a microcontroller, an application specific integrated circuit (ASIC) (e.g., or communicate with ASIC 1210), a field programmable gate array (FPGA), a programmable logic device, a discrete gate or transistor logic component, a discrete hardware component, or any combination thereof). In some cases, the main processor 1270 is configured to operate a memory array using a memory controller. In other cases, a memory controller is integrated into the processor. In some cases, the main processor 1270 is configured to execute computer-readable instructions stored in a memory to perform various functions. In some embodiments, a main processor 1270 includes special purpose components for modem processing, baseband processing, digital signal processing, or transmission processing.

The main processor 1270 may control the wireless communication device 1200 by executing a plurality of instructions. For example, the main processor 1270 may also control the ASIC 1210 and the ASIP 1230 and may process data received via the wireless communication network or process a user input to the wireless communication device 1200. The main memory 1290 may communicate with the main processor 1270 and may store, as a non-volatile storage, a plurality of instructions executed by main processor 1270. For example, the main memory 1290 may include an arbitrary-type memory accessible by the main processor 1270, as a non-limited example, such as RAM, ROM, a tape, a magnetic disk, an optical disk, a volatile memory, a non-volatile memory, and a combination thereof.

While the present disclosure has been particularly shown and described with reference to embodiments thereof, it will be understood that various changes in form and details may be made therein without departing from the spirit and scope of the following claims.

What is claimed is:

1. A method comprising:
receiving a first synchronization signal including at least one first synchronization signal block (SSB) from a serving base station and a second synchronization signal including at least one second SSB from a neighboring base station, wherein the second synchronization signal including the at least one second SSB overlaps a slot through which data is transmitted from the serving base station;
measuring a first received power and a received reference signal received power (RSRP) of each of the first synchronization signal and the second synchronization signal received on the slot; and
calculating an effective RSRP corresponding to at least one additional SSB received from the serving base station, the effective RSRP calculated based at least in part on a correlation power, wherein the correlation power is based at least in part on a cross correlation between the received RSRP, the first received power, the data, and the at least one additional SSB.

2. The method of claim 1, further comprising:
measuring a signal-to-interference-plus-noise ratio (SINR) based at least in part on the first synchronization signal and the second synchronization signal received on the slot; and
comparing the SINR with a predefined threshold.

3. The method of claim 2, wherein the effective RSRP is calculated based at least in part on detecting that the SINR is less than the predefined threshold.

4. The method of claim 1, further comprising:
determining whether the first received power detected on the slot exceeds the received RSRP.

5. The method of claim 4, wherein the effective RSRP is calculated based at least in part on detecting that the first received power detected on the slot exceeds the received RSRP.

6. The method of claim 1, wherein calculating the effective RSRP further comprises:
measuring a second received power corresponding to the data based at least in part on the first received power detected on the slot, the received RSRP, and the correlation power; and
obtaining the effective RSRP by subtracting, from the received RSRP, a product of the second received power corresponding to the data and the correlation power.

7. The method of claim 6, wherein the second received power corresponding to the data is obtained based at least in part on dividing a first value by a second value, the first value obtained by subtracting the received RSRP from the first received power and the second value obtained by subtracting the correlation power from 1.

8. The method of claim 6, further comprising:
determining whether a handover condition is satisfied based on the effective RSRP and the received RSRP corresponding to the at least one first SSB; and
performing a handover from the serving base station to the neighboring base station based at least in part on determining the handover condition is satisfied.

9. An apparatus comprising:
a communication circuit configured to receive a first synchronization signal including data on a resource of at least one first synchronization signal block (SSB) from a serving base station and to receive a second synchronization signal including at least one second SSB from a neighboring base station, the second synchronization signal including the at least one second SSB transmitted to an additional resource that corresponds to the resource of the at least one first SSB that includes the data;
a memory configured to store a simulation value of a correlation coefficient based on cross correlation between the data and the at least one second SSB; and
a control circuit,
wherein the control circuit comprises a reference signal received power (RSRP) update circuit configured to measure each of a received RSRP and a first received power based at least in part on using the data received on the resource and the at least one second SSB and to calculate an effective RSRP corresponding to at least one additional SSB received from the serving base station, the effective RSRP calculated based at least in part on the received RSRP, the first received power, and a simulation value stored in the memory.

10. The apparatus of claim 9, wherein the RSRP update circuit is configured to measure a signal-to-interference-plus-noise ratio (SINR) based at least in part on the data received on the resource and the at least one additional SSB and to compare the SINR with a predefined threshold.

11. The apparatus of claim 10, wherein the RSRP update circuit is configured to calculate the effective RSRP based at least in part on detecting that the SINR is less than the predefined threshold.

12. The apparatus of claim 9, wherein the RSRP update circuit is configured to determine whether the first received power exceeds the received RSRP.

13. The apparatus of claim 12, wherein the RSRP update circuit is configured to calculate the effective RSRP based at least in part on detecting the first received power exceeds the received RSRP.

14. The apparatus of claim 9, wherein the RSRP update circuit is configured to measure a second received power corresponding to the data based at least in part on the first received power, the received RSRP, and the simulation value, and to obtain the effective RSRP by subtracting, from the received power, a product of the second received power corresponding to the data and the simulation value, and
wherein the second received power of the data is obtained based at least in part on dividing a first value by a second value, the first value obtained by subtracting the received RSRP from the first received power and the second value obtained by subtracting the correlation power from 1.

15. A wireless communication system comprising:
a serving base station configured to transmit, to an electronic device, a first synchronization signal block (SSB) burst set including a first SSB and data;
a neighboring base station configured to transmit, to the electronic device, a second SSB burst set including a second SSB, the second SSB transmitted on an additional slot that corresponds to a slot for the data; and
the electronic device configured to measure each of a first received power, a received reference signal received power (RSRP), and a signal-to-interference-plus-noise ratio (SINR) based at least in part on the data received on the slot and the second SSB and to calculate, based at least in part on determining the SINR is less than a threshold, an effective RSRP corresponding to the second SSB based at least in part on the received RSRP, the first received power, the data, and a correlation power, the correlation power based at least in part on a cross correlation of the second SSB.

16. The wireless communication system of claim 15, wherein the electronic device bypasses calculation of the effective RSRP based at least in part on determining the SINR is greater than the threshold.

17. The wireless communication system of claim 15, wherein the electronic device obtains a second received power corresponding to the data by dividing a first value by a second value, the first value obtained by subtracting the received RSRP from the first received power and the second value obtained by subtracting the correlation power from 1.

18. The wireless communication system of claim 17, wherein the electronic device obtains the effective RSRP by subtracting, from the received RSRP, a product of the second received power corresponding to the data and the correlation power.

19. The wireless communication system of claim 18, wherein the electronic device calculates a serving RSRP based at least in part on the first SSB and compares the serving RSRP with the effective RSRP.

20. The wireless communication system of claim 19, wherein the electronic device determines whether a handover condition is satisfied based at least in part on the serving RSRP and the effective RSRP and determines whether to perform a handover from the serving base station to the neighboring base station based at least in part on the handover condition being satisfied.
